(19) United States
(12) Patent Application Publication
(10) Pub. No.: US 2008/0151976 A1
(43) Pub. Date: Jun. 26, 2008

(54) Ultra wideband communications systems

(75) Inventor: William Stoye, Cambridge (GB)

Correspondence Address: STERNE, KESSLER, GOLDSTEIN & FOX P.L.L.C., 1100 NEW YORK AVENUE, N.W., WASHINGTON, DC, 20005, US

(73) Assignee: Artimi, Inc., Santa Clara, CA (US)

(21) Appl. No.: 11/714,217

(22) Filed: Mar. 6, 2007

(30) Foreign Application Priority Data
Dec. 22, 2006 (GB) 0625570.7

(51) Int. Cl. H04L 27/28; H04B 1/38

(52) U.S. Cl. 375/219; 375/260; 375/E01.002

(57) ABSTRACT

The invention relates to communications protocols for very high-speed data transmission, in particular burst mode packet data communications for ultra wideband (UWB) communications systems. We describe a method of sending a burst of data packets from a first OFDM transceiver to a second OFDM transceiver, said transceivers having a set of OFDM synchronisation symbols for synchronising communications between the transceivers, the method comprising: sending said data packets from said first to said second transceiver, and between sending at least some of said data packets of said bursts receiving acknowledgement data from said second transceiver at said first transceiver; and wherein said acknowledgement data is encoded using said OFDM synchronisation symbols.

### BACKGROUND OF THE INVENTION

1. Field of the Invention

This invention relates to communications protocols for very high-speed data transmission, in particular burst mode packet data communications for ultra wideband (UWB) communications systems.

2. Background Art

The MultiBand OFDM (orthogonal frequency division multiplexed) Alliance (MBOA), more particularly the WiMedia Alliance, has published a standard for a UWB physical layer (PHY) for a wireless personal area network (PAN) supporting data rates of up to 480 Mbps. This document was published as, “MultiBand OFDM Physical Layer Specification”, release 1.1, Jul. 14, 2005; release 1.2 is now also available. The skilled person in the field will be familiar with the contents of this document, which are not reproduced here for conciseness. However, reference may be made to this document to assist in understanding embodiments of the invention. Further background material may be found in Standards ECMA-368 & ECMA-369.

Broadly speaking a number of band groups are defined, one at around 3 GHz, a second at around 6 GHz, each comprising three bands; the system employs frequency hopping between these bands in order to reduce the transmit power in any particular band. The OFDM scheme employs 110 sub-carriers including 100 data carriers (a total FFT size of 128 carriers), which, at the fastest encoded rate, carry 200 bits using DCM (dual carrier modulation). A ¾ rate Viterbi code results in a maximum data under the current version of this specification of 480 Mbps.

The OFDM symbols are transmitted at 3.2 MHz and for each of these an IFFT (inverse fast Fourier transform) is performed. FIG. 1 shows a data packet in the system, which has an initial packet synchronisation sequence comprising 24 OFDM synchronisation symbols (when not in burst mode). At the receiver time-domain correlation is performed to find these synchronisation symbols, set the gain and the like, in order to locate the following symbols on which an FFT is to be performed to recover the data. As can be seen in FIG. 1, after the synchronisation symbols there follows a set of six channel estimation symbols, then 12 packet header symbols (h), and then the packet payload. The payload can comprise up to 4 Kb of user data. At the highest data rates the overhead, as compared to the payload, of a data packet becomes significant. This is shown in more detail in FIG. 2.

FIG. 2 shows a data packet according to a WiMedia PHY protocol in more detail, and shows the different parts of the data packet approximately to scale relative to one another. In FIG. 2 (and the following figures) the cross-hatched regions represent the back channel. The data packet 20 comprises an initial packet synchronisation sequence (SYNC) 22 followed by a channel estimation sequence (CHE) 24 followed by a PHY and MAC header (h, HDR) 26 followed by a 4095 byte SDU (service data unit) payload 28 at 480 Mbps, followed by a gap 30 referred to as the Short Inter-frame Spacing (SIFS), lasting 10 μs, followed by an acknowledgement (ACK) packet 32, followed by a further SIFS 34. At this point the illustrated packet effectively loops round back to the start for a further SYNC sequence 22. The WiMedia specification requires that the receive-to-transmit turnaround time is not greater than the SIFS time. More particularly, because the receiver needs to process the payload 28 in order to determine whether or not this was received correctly the SIFS interval allows the receiver time to finish receiving the payload, apply the Viterbi track-back and decide if the CRC (cyclic redundancy check) is correct before sending an acknowledgement. (There may be other steps at the PHY and MAC levels before deciding whether to send an ack; these are just examples). The actual turnaround time of the RF stage in a UWB receiver may, however, be very quick, for example of order nanoseconds, and this recognition is important for understanding embodiments of the invention described later.

Turning to the acknowledgement packet 32 in more detail, this essentially comprises a normal packet within the specification but without the payload data 28. The ACK packet 32 has its own synchronisation sequence because the receiver at the transmitter (transceiver) is not synchronised after the SIFS interval 30. This is because, inter alia, the distance between the transmitter and receiver (which in fact are both transceivers) is generally unknown and variable and that the data rates at which the system is operating this has a significant effect on synchronisation. Similarly it is also assumed that the channel estimate is valued for 1 packet only.

In single packet transmission mode once the inter-frame spacing and acknowledgement packet are taken into account, although the “headline” protocol rate is 480 Mbps the 4095 bytes in the payload are transmitted in 115.625 μs given an overall data rate of 283 Mbps or approximately 59% efficiency (59% of 480 Mbps).

To address this the WiMedia PHY specification includes a burst mode, which provides a faster throughput at the expense of increased buffering at both ends. Particularly in a single chip design this increased buffering can present difficulties as the on-chip memory uses a significant proportion of the overall area of the chip.

FIGS. 3a and 3b show, respectively, two-packet and four-packet bursts with a burst acknowledge (ACK) in accordance with a WiMedia PHY specification. Like elements to those of FIG. 2 are indicated by like reference numerals. In burst mode the ACK 32 has a small payload 32a associated with the header to enable the acknowledge to say which packet was received correctly and hence enable selective retries. Between each packet of the burst there is a reduced gap, the MIFS (Minimum Inter-frame Spacing) gap 36; this gap has a duration of 6 symbols, that is 1.875 μs. There is also a shortened SYNC sequence, the burst SYNC 38 which comprises 12 rather than 24 symbols.

Under the existing protocol a two-packet burst with a burst acknowledge transmits 8190 bytes in 198 μs, that is an overall throughput of 331 Mbps, 69% of 480 Mbps; with a four-burst 16380 bytes are transmitted in 359 μs giving an overall throughput of 365 Mbps, that is 76% of 480 Mbps. However, for a burst of four or more packets the buffering requirements become severe, in particular for an embedded (single-chip) solution. Moreover the inventors have recognised that in future versions of the PHY specification the payload rate may be increased still further, for example to 960 Mbps, when these efficiency values suffer further.

### SUMMARY OF THE INVENTION

According to a first aspect of the invention there is therefore provided a method of sending a burst of data packets from a first OFDM transceiver to a second OFDM transceiver, said transceivers having a set of OFDM synchronisation symbols for synchronising communications between the transceivers, the method comprising: sending said data packets from said first to said second transceiver, and between sending at least some of said data packets of said bursts receiving acknowledgement data from said second transceiver at said first transceiver; and wherein said acknowledgement data is encoded using said OFDM synchronisation symbols.

An advantage of using OFDM synchronisation symbols to send the acknowledgement data is that in embodiments of the method there is no need to perform an FFT on the received data—instead the acknowledgement data can be obtained directly from the synchronisation portion of the receiver in the sending transceiver. In embodiments of the method the acknowledgement data is thus encoded using only synchronisation symbols.

More particularly in embodiments of the method the acknowledgement data is encoded by modulating a sequence of the synchronisation symbols with a cover sequence. The cover sequence may comprise a sequence of +1 and −1 values (normal or inverted/180° phase shift) which multiplies the synchronisation symbols. A UWB receiver has a synchronisation module towards the front end which is able to detect whether a synchronisation symbol is normal or inverted or, more particularly, is able to detect a relative inversion (or phase shift) of one synchronisation symbol with respect to another, and thus the acknowledgement data may be retrieved from this synchronisation module effectively directly. In embodiments this facilitates very high speed acquisition of the acknowledgement data and means that there is no need for conventional OFDM demodulation. More particularly therefore, in embodiments, the encoding of the acknowledgement data uses a differential code comprising inverted and non-inverted versions of the synchronisation symbols.

In a practical protocol it is important to reduce the risk of a false acknowledge of a data packet having been correctly received since instead of a single packet re-try this could require the re-transmission of a complete burst of data packets. In particular in a wireless local or personal area network there is a risk that a “third party” transmitter could send a sequence of synchronisation symbols which would appear to be acknowledgement data acknowledging that a data packet had been correctly received. Preferably, therefore, the cover sequence modulating the synchronisation symbols with the acknowledgement data comprises an illegal sequence, that is one which is not used for synchronising communications between the transceivers or, more generally, between any transceivers within a network within which the transceivers are operating. For example, in the case of the WiMedia PHY specification a number of legal sequences of synchronisation symbols are defined and, preferably, none of these are used to transmit the acknowledgement data.

In some particularly preferred embodiments of the method the short burst synchronisation sequence between data packets of the burst are omitted and, instead, the receiving transceiver performs tracking of the transmit clock of the transmitting transceiver over substantially all the duration of a burst. The applicants have established that this can be achieved within the 20 ppm variation allowed in the clocks at each end of a link. Thus, preferably, no legal synchronisation symbol sequences are transmitted between the data packets of the burst. Further in embodiments the acknowledgement data is encoded using 12 synchronisation symbols or less than 12 synchronisation symbols.

Further, counter to prevailing prejudice in the art, the inventor has recognised that the MIFS gap in the existing protocol need not be present and, instead, may be employed to send acknowledgement data for packets of the burst. In embodiments the timing, more particularly the need of the receiver to process a received packet before the acknowledgement can be sent, is such that not every slot between packets is used for acknowledgement data, but only every slot after the first. In other words in embodiments of the method the first packet is transmitted, there is a short gap (for example equal to the MIFS gap) and then the second packet is transmitted, the receiver processing the first packet whilst the second packet is being received, then the receiver transmitting an acknowledgement of the first packet (payload) in the interval between the second and third packets. Thus, in effect, the acknowledgement data relates to the previous-but-one data packet. At the end of the burst the final acknowledgement may either acknowledge the last and the last but one transmitted packet of the burst or, more preferably, the acknowledgement may be for the correct reception of the entire burst (payload).

In preferred embodiments of the method the duration between the end of the final symbol of one data packet (payload) of the burst and the start of the reception of the first (synchronisation) symbol of the acknowledgement is less than one OFDM symbol in duration. Likewise, preferably, the interval between the end of the last symbol of the acknowledgement data and the start of transmission of the first symbol of the next data packet is less than one OFDM symbol in duration (measurements of these durations should be made at the air interface). These timings, in particular the timing between completion of sending a data packet and receiving the acknowledgement, are possible in a UWB communications link because the relatively short range of UWB communications. More particularly the speed-of-light round trip time between the two transceivers should be less than an OFDM symbol duration (approximately 30 ns corresponding to an approximately 10 m round trip).

In embodiments of the method all the synchronisation symbols received in the acknowledgement interval between packets are used to encode a single bit of acknowledgement data, for best confidence. Thus where there is, for example, a six symbol interval between one packet of a burst and the next, with one symbol allowed for the round trip, there are then five symbols remaining for encoding the acknowledgement data and, with a differential encoding, four bits which may be transmitted. In the general case for an n symbol duration between packets of the burst n-2 bits may be transmitted. Preferably all these bits are used to encode the acknowledgement data, which comprise a single bit (acknowledged or not-acknowledged). However in other embodiments these bits may be used to encode other data, additionally or alternatively to the acknowledgement data, for example to provide a very low data rate back channel. In still other embodiments, the acknowledgement data may comprise two or more bits, for example, yes, no and not sure, for example the latter indicative of some quality of service or reception problem. The skilled person will further understand that, although in some preferred embodiments the MIFS gap is used to receive acknowledgement data, in other embodiments the acknowledgement data may be received instead of sending a burst sync sequence (for example using 12 symbols) and/or some other duration of neither 6 nor 12 symbols may be employed for the acknowledgement data reception. As previously mentioned, however, in some preferred embodiments the 6 symbol MIFS gap is employed to receive the acknowledgement data, thus dispensing with substantially any inter-frame spacing for all of the data packets in a burst expect one.

In embodiments of the method, despite the lack of any MIFS gap (except between the first and second data packets), and even though acknowledgement data is received between data packets of the burst, a maximum throughput data transmission rate of at least 400 Mbps may be achieved, in particular, at a payload rate of 480 Mbps. Embodiments of the method provide an overall efficiency of at least 80% (throughput compared with actual payload transmission data rate) with an 8 packet burst at 480 Mbps, and of at least 70% for an 8 packet burst at 960 Mpbs.

The invention also provides an OFDM transceiver having a burst mode for sending a burst of data packets to a second OFDM transceiver, said transceiver having a set of OFDM synchronisation symbols for synchronising communications between the transceivers, the OFDM transceiver comprising: an OFDM transmitter to send said data packets of said burst to said second OFDM transceiver; and an OFDM receiver to receive acknowledgement data between sending at least some of said data packets of said burst, wherein said acknowledgement data is encoded using said OFDM synchronisation symbols.

In a related aspect the invention provides a UWB transceiver burst mode packet data communications protocol for operation at a raw data rate of at least 400 Mbps, in said burst mode a burst of data packets being transmitted, the protocol comprising sending an initial data packet with a synchronisation sequence then sending a succession of subsequent data packets of said burst, and wherein acknowledgement data for a packet is received between transmissions of said subsequent data packets.

In embodiments of the protocol method the acknowledgement data comprises an acknowledgement (ACK/NAK) for a previous-but-one transmitted data packet. Thus in embodiments there is an acknowledgement after each data packet of the burst except the first. At the end there is preferably a final acknowledgement of all the data packets of the burst. There may be a shortened gap before this final acknowledgement, more particularly the receiving transceiver may begin transmitting this acknowledgement at least a sync or preamble part of this acknowledgement—before a decision whether or not to acknowledge correct receipt of the package has been made at the receiver.

The acknowledgement data may include other data transmitted from the receiving transceiver to the transceiver sending the burst of data packets. Preferably, however, the data comprises a single bit of data encoding an acknowledged/not-acknowledged message. In embodiments of the protocol the burst mode is halted if the acknowledgement data cannot be decoded, since this may be symptomatic of a more serious problem with the link than simply the (correctable) errors which are usually expected at high data rates.

Preferably the acknowledgement data is encoded using synchronisation symbols of the protocol, preferably modulating these with a cover sequence which is not a valid synchronisation sequence within the protocol. Preferably no (valid) synchronisation sequence is included between the data packets of the burst of data packets.

In embodiments of the protocol, although synchronisation symbols are generally transmitted at a high or maximum level to enable them to easily be detected, preferably the synchronisation symbols comprising the acknowledgement data are transmitted at a reduced signal level, less than the maximum, for example to achieve at the sending transceiver substantially the same level as the channel estimate, header or payload symbols of the data burst have at the receiving transceiver sending the acknowledgement (i.e. approximately reciprocal gain, similar for the sending and receiving transceivers). As previously mentioned, the PHY specification defines hopping between the bands of a band group but in embodiments of the protocol such hopping may not be required if the signal level of the acknowledgement data is reduced, for example as previously described. Thus in embodiments of the protocol frequency hopping is not used when communicating the acknowledgement data. This facilitates decoding of the acknowledgement data using the synchronisation circuitry in the sending transceiver.

The invention also provides a UWB communications system having a burst mode packet data communications protocol for operation at a raw data rate of at least 400 Mbps, in said burst mode a burst of data packets being transmitted, the protocol comprising sending an initial data packet with a synchronisation sequence then sending a succession of subsequent data packets of said burst, and wherein acknowledgement data for a packet is received between transmissions of said subsequent data packets.

The above described methods and protocols are particularly useful for short range, very high bandwidth wireless personal or local area networks, for example for video distribution, communications between portable devices, bulk data synchronisation say between a still or video camera and a computer, and the like.

The invention further provides an OFDM transmitter, receiver, transceiver and communications system to implement the above-described protocols and methods.

The invention still further provides processor control code to implement the above-described protocols and methods, in particular on a data carrier such as a disk, CD- or DVD-ROM, programmed memory such as read-only memory (Firmware), or on a data carrier such as an optical or electrical signal carrier. Code (and/or data) to implement embodiments of the invention may comprise code for a hardware description language such as Verilog (Trade Mark) or VHDL (Very high speed integrated circuit Hardware Description Language) or SystemC. As the skilled person will appreciate such code and/or data may be distributed between a plurality of coupled components in communication with one another.

In a further aspect the invention provides an OFDM UWB transceiver having a burst mode for packet data communications in which a burst of data packets is transmitted, the transceiver including synchronisation circuitry to synchronise received OFDM packets for demodulation, and wherein said transceiver is configured to use said synchronisation circuitry during intervals between transmission of data packets of a said burst to receive acknowledgement data for said data packets of said burst.

Broadly speaking, in embodiments the sending transceiver is configured to re-use existing synchronisation circuitry to recover the acknowledgement data. This may then be passed to the MAC (medium access control) for use in determining whether or not the receiving transceiver correctly received the data and, if not, for controlling re-transmission of one or more packets of a burst. The transceiver is configured is use the synchronisation circuitry in the brief gaps between transmitting data packets of a burst. To decode a cover sequence modulating received synchronisation symbols and to recover an ACK/NAK signal from the receiving transceiver.

In a complementary fashion the invention further provides an OFDM UWB transceiver having a burst mode for packet data communications in which a burst of data packets is received, wherein said transceiver is configured to send acknowledgement data for said data packets of said burst encoded using synchronisation symbols.

In embodiments the packet-receiving transceiver is configured to send the acknowledgement data between reception of data packets of the burst, more particularly by modulating a series of synchronisation symbols with a cover sequence corresponding to an ACK or NAK message.

The invention still further provides an OFDM UWB signal comprising a burst of data packets preceded by a synchronisation sequence including synchronisation symbols, in which acknowledgement data is included between said data packets, said acknowledgement data being encoded using said synchronisation symbols.

In embodiments the OFDM UWB signal belongs to a protocol and the acknowledgement data is encoded using only synchronisation symbols of this protocol; preferably these are modulated with a cover sequence which is not a valid synchronisation sequence within the protocol.

The invention still further provides a method of acknowledging a data packet in an OFDM UWB packet data communications system, the method comprising transmitting at least one data packet from a first transceiver to a second transceiver and acknowledging reception of said at least one data packet by sending an acknowledgement packet from said second to said first transceiver, said acknowledgement packet including a synchronisation sequence followed by an acknowledgement payload defining whether reception of said at least one data packet is acknowledged, and wherein said sending of said synchronisation sequence of said acknowledgement packet commences before said second transceiver has determined whether said reception of said at least one data packet is to be acknowledged.

The skilled person will understand that applications of this aspect of the invention (unlike some of the described embodiments) do not require bursts or sync-only ack packets. In embodiments it gains by reducing turnaround time. However preferred implementations require that both ACK and NAK response packets be legitimate. Implementations of embodiments of this aspect of the invention can be tied to a header bit in the tx packet, saying “immediate ack requested”. This permits the receiving PHY to start to send an immediate reply, even before the decoding of the payload has been completed.

When receiving the ACK or NAK, the data transmitting PHY can be placed in a mode which starts the transmission of the next data packet before the ACK or NAK has been decoded. This will further reduce the inter-packet delays, but (preferably) entirely under control of the data-sending PHY. The ACK or NAK packet may optionally have a further bit or flag that determines whether this is permissible, and/or multi-bit information requesting a delay. This can give the receiving station some ability to control the rate. For low cost devices moving huge volumes of data, active flow control can reduce the need for buffering. At multi-gigabit speeds data buffering can become the dominant silicon cost in the presence of quite small real-time delays.

Embodiments of this aspect of the invention and related concepts can also be applied to the ACK for the final packet of a burst, as well as to single non-burst packets.

The invention also provides an OFDM UWB receiver for an OFDM UWB packet data communications system, the receiver comprising a system for acknowledging reception of a data packet by sending an acknowledgement packet said acknowledgement packet including a synchronisation sequence followed by an acknowledgement payload defining whether reception of said at least one data packet is acknowledged, and wherein said receiver is configured to commence said sending of said synchronisation sequence of said acknowledgement packet before the receiver has determined whether said reception of said at least one data packet is to be acknowledged.

Thus in embodiments of the method the receiving PHY may perform an “auto-turnaround”, starting to transmit the preamble (sync) of the acknowledgement packet substantially immediately after the reception of a data packet, which may either be a “single” data packet or the last data packet of a burst. The data packet may be acknowledged (rather than not-acknowledged) if the payload has been correctly (or correctably) or validly received.

This may be termed an “auto-acknowledge” mode and the use of such a mode may be signalled, for example in a header of a data packet within the system.

Features of the above described embodiments of the invention may also be combined in any permutation.

### BRIEF DESCRIPTION OF THE DRAWINGS/FIGURES

FIG. 1 shows a WiMedia PHY data packet;

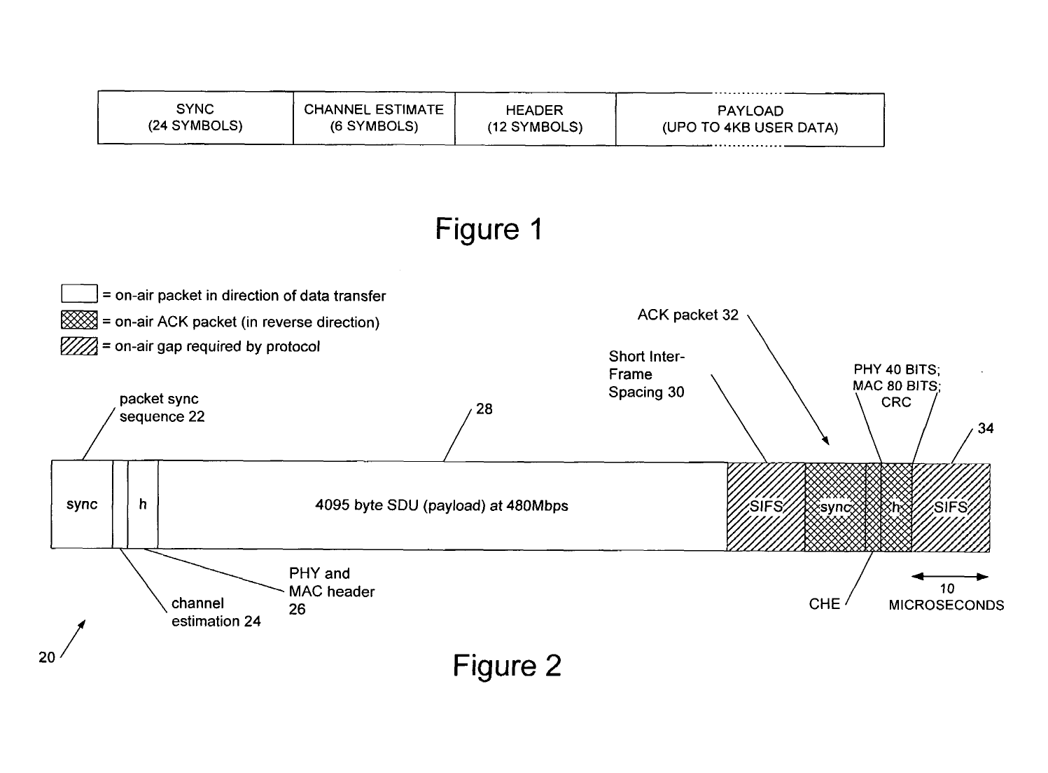

FIG. 2 shows a WiMedia data packet with acknowledge;

FIGS. 3a and 3b show, respectively two- and four-packet bursts in a WiMedia PHY;

FIG. 4 shows an example of an 8-packet burst with acknowledge in an OFDM UWB protocol according to an embodiment of the invention;

FIGS. 5a to 5c show how a 960 Mbps data rate would appear in a faster version of the WiMedia PHY protocol showing figures corresponding to, respectively, FIGS. 2, 3a and 3b;

FIG. 6 shows an example of an 8-packet burst with acknowledge in a 960 Mbps communication system according to an embodiment of the invention;

FIG. 7 shows, schematically, details of an inter-burst-packet acknowledgement for the schemes of FIGS. 4 and 6;

FIG. 8 shows a block diagram of a digital OFDM UWB transmitter sub-system;

FIG. 9 shows a block diagram of a digital OFDM UWB receiver sub-system;

FIGS. 10a and 10b show, respectively, a block diagram of a PHY hardware implementation for an OFDM UWB transceiver according to an embodiment of the invention, and an example of an RF front end for the receiver of FIG. 10a.

### DETAILED DESCRIPTION OF PREFERRED EMBODIMENTS

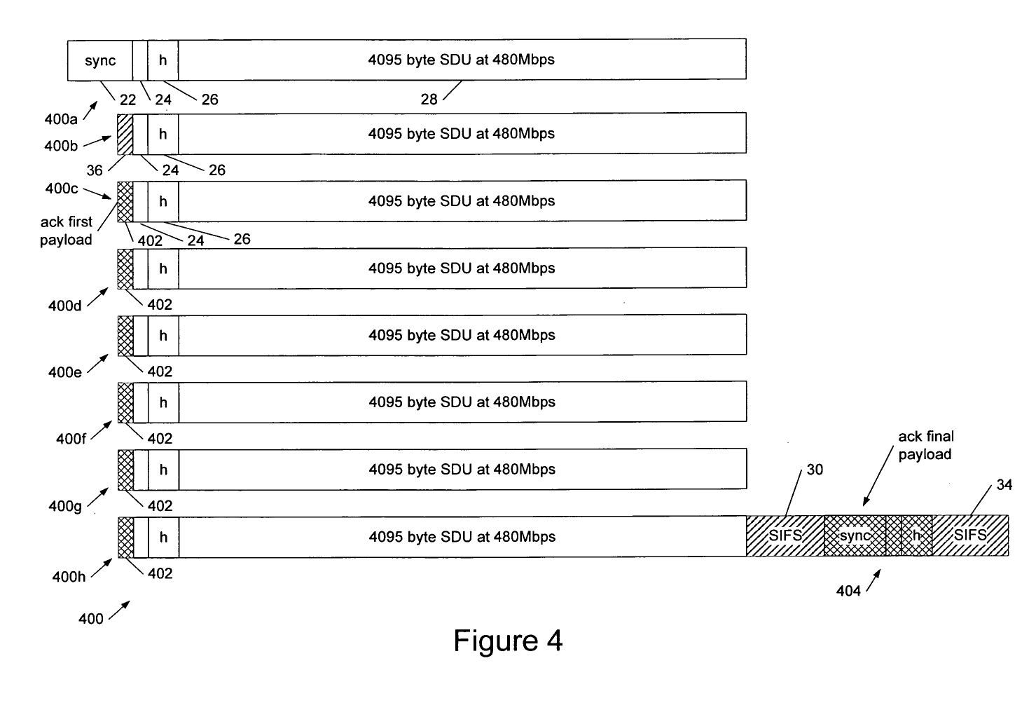

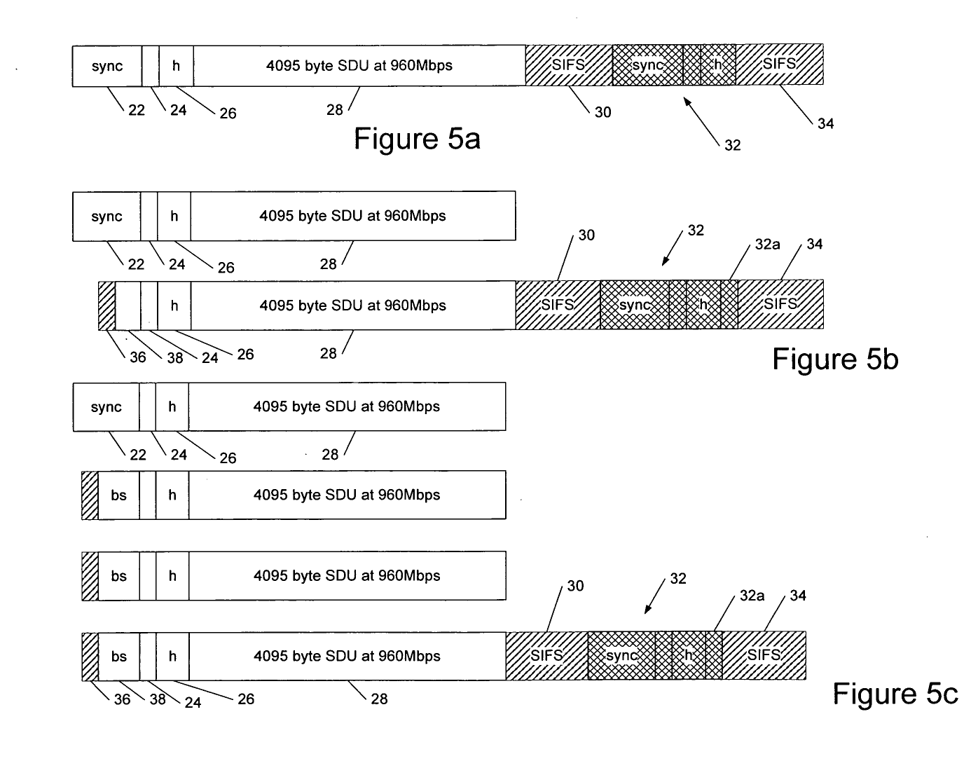

Referring now to FIG. 4, this shows, schematically, a burst mode protocol according to an embodiment of the invention, which the inventor refers to as a “dense burst” mode. A burst 400 comprising eight data packets 400a-h is shown and like elements to those previously described are indicated by like reference numerals. Thus it can be seen that the initial packet 400a corresponds to that shown in FIG. 3a but the subsequent protocol differs. More particularly, although there is a MIFS gap 36 after the first data packet, this gap is occupied by acknowledgement data 402 after each subsequent packet of the burst except for the last when the protocol, in one embodiment, concludes similarly to before. The protocol does not, in fact, conclude precisely the same way since the final acknowledgement 404 may either comprise an acknowledgement of the last two packets of the burst (either separately so that an acknowledgement of each of the last two packets can be distinguished, or together) or an acknowledgement of the entire burst. As the receiver needs time to process the data in a packet to determine whether or not it has been properly received before the acknowledgement data (acknowledged or not-acknowledged) can be sent the third data packet 402c contains acknowledgement data for the first data packet 400a, the fourth data packet 402d contains acknowledgement data for the second data packet 402b and so forth. A further difference between the protocol of FIG. 4 and that of FIG. 3 is that the burst synch symbols 38 are omitted between data packets of the burst.

The acknowledgement data 402 of each packet except the last (and last but one) is in the example of FIG. 4 a time slot of MIFS has been allowed for this. If a NAK is sent or if the transmitter cannot decode the ACK/NAK then the transmitter can resend a payload of part of the same burst: each payload has a PHY+ MAC header which describes its content. This has the advantage that the MAC buffering requirement is not affected by the burst length, allowing longer bursts to be used in practice. S similar technique may be used with the final payload acknowledge 404, although then preferably some delay is allowed in order to permit the receiver to complete reception of the final payload. Removal of the burst synch header is possible because the timing recovery in the receiver can cover the whole burst, thus further contributing to overall efficiency.

In the example of FIG. 4 32760 bytes are sent in 653 micro seconds, that is an overall throughput of 401 Mbps, an efficiency of 84% (of 480 Mbps). (See throughput numbers given in this specification are best-case, assuming no packet loss).

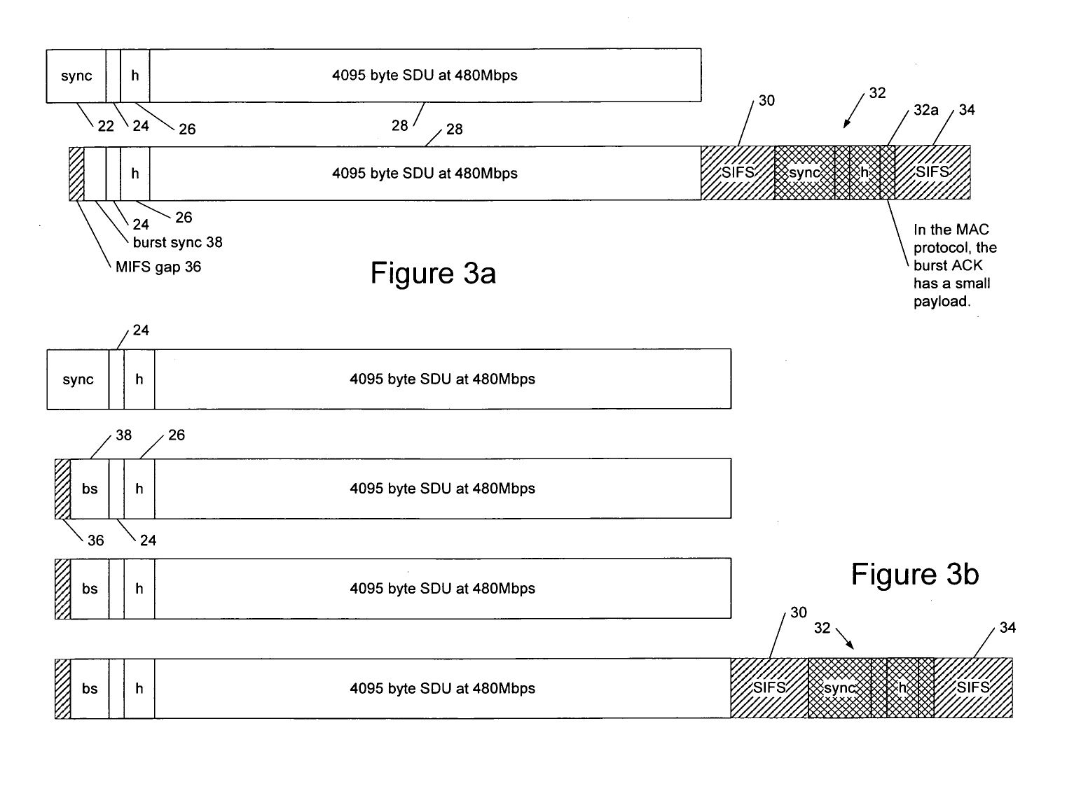

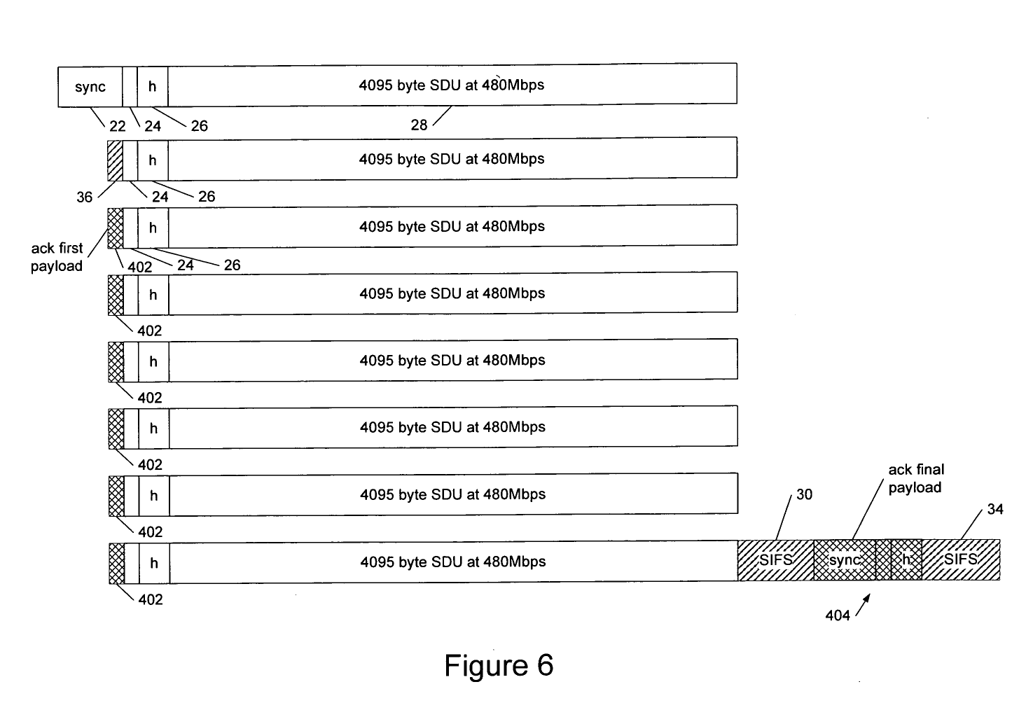

If higher data rates than 408 Mbps then the benefit from the protocol shown in the FIG. 4 is increased. The benefits are greatest for faster data rates. Thus referring to FIGS. 5a to 5c these show schematic illustrations similar to those of FIGS. 2 and 3a and 3b illustrating what the performance of the WiMedia standard would be were it to specify operation at 960 Mbps.

In FIG. 5a 409 bytes are transmitted in 81.75 microseconds, that is 400 Mbps or 42% of 960 Mbps. In the two-packet burst with burst acknowledge of FIG. 5b 8190 bytes are sent in 130.625 microseconds, that is a throughout of 502 Mbps, 52% of 960 Mbps. In the example of FIG. 5c, with a 4-packet burst with burst acknowledge 16380 bytes are sent in 224.375 microseconds, that is a throughout of 584 Mbps, 61% of 960 Mbps.

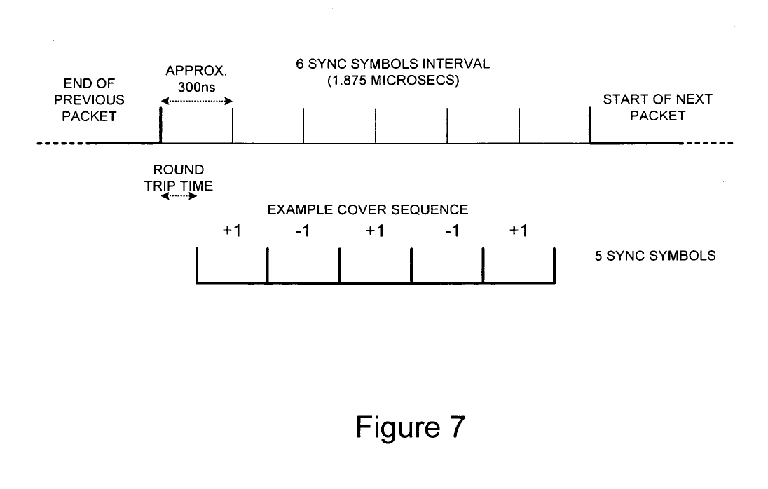

Referring now to the protocol of FIG. 6, which corresponds to that of FIG. 4 but for 960 Mbps, in this example of an 8-packet burst with burst acknowledge 32760 bytes are sent in 383.75 microseconds, that is a throughout of 683 Mbps, 71% of 960 Mbps. It can be seen that this represents a substantial improvement.

These results are summarised in Table 1 below.

TABLE 1

| | Data | Rate | OFDM | | Throughput | |
|---|---|---|---|---|---|---|
| Item | (bytes) | (Mbps) | symbols | time (us) | Mbits/sec | Efficiency |
| SYNC | | | 24 | 7.5 | | |
| BSYNC | | | 12 | 3.75 | | |
| CHE | | | 6 | 1.875 | | |
| HDR | | | 12 | 3.75 | | |
| SIFS | | | 32 | 10 | | |
| MIFS | | | 6 | 1.875 | | |
| ACK packet | | | 42 | 13.125 | | |
| block-ACK packet | | | 48 | 15 | | |
| 4095 byte sdu at | 4095 | 480 | 222 | 69.375 | 472 | 98% |
| 480 Mbps | | | | | | |
| 4095 byte packet | 4095 | 480 | 264 | 82.5 | 397 | 83% |
| 4095 byte packet, SIFS, | 4095 | 480 | 370 | 115.625 | 283 | 59% |
| ACK, SIFS | | | | | | |
| | | | | 0 | | |
| 4095 byte burst packet | 4095 | 480 | 252 | 78.75 | 416 | 87% |
| 2-packet burst, SIFS, | 8190 | 480 | 634 | 198.125 | 331 | 69% |
| ACK, SIFS | | | | | | |
| | | | | 0 | | |
| 4-packet burst, SIFS, | 16380 | 480 | 1150 | 359.375 | 365 | 76% |
| ACK, SIFS | | | | | | |
| | | | | 0 | | |
| | | | | 0 | | |
| 4-packet dense burst, | 16380 | 480 | 1108 | 346.25 | 378 | 79% |
| SIFS, ACK, SIFS | | | | | | |
| | | | | 0 | | |
| 8-packet dense burst, | 32760 | 480 | 2092 | 653.75 | 401 | 84% |
| SIFS, ACK, SIFS | | | | | | |
| | | | | 0 | | |
| | | | | 0 | | |
| 4095 byte sdu at | 4095 | 960 | 114 | 35.625 | 920 | 96% |
| 960 Mbps | | | | | | |
| 4095 byte packet | 4095 | 960 | 156 | 48.75 | 672 | 70% |
| 4095 byte packet, SIFS, | 4095 | 960 | 262 | 81.875 | 400 | 42% |
| ACK, SIFS | | | | | | |
| | | | | 0 | | |
| 4095 byte burst packet | 4095 | 960 | 144 | 45 | 728 | 76% |
| 2-packet burst, SIFS, | 8190 | 960 | 418 | 130.625 | 502 | 52% |
| ACK, SIFS | | | | | | |
| | | | | 0 | | |
| 4-packet burst, SIFS, | 16380 | 960 | 718 | 224.375 | 584 | 61% |
| ACK, SIFS | | | | | | |
| | | | | 0 | | |
| | | | | 0 | | |
| 4-packet dense burst, | 16380 | 960 | 676 | 211.25 | 620 | 65% |
| SIFS, ACK, SIFS | | | | | | |
| | | | | 0 | | |
| 8-packet dense burst, | 32760 | 960 | 1228 | 383.75 | 683 | 71% |
| SIFS, ACK, SIFS | | | | | | |

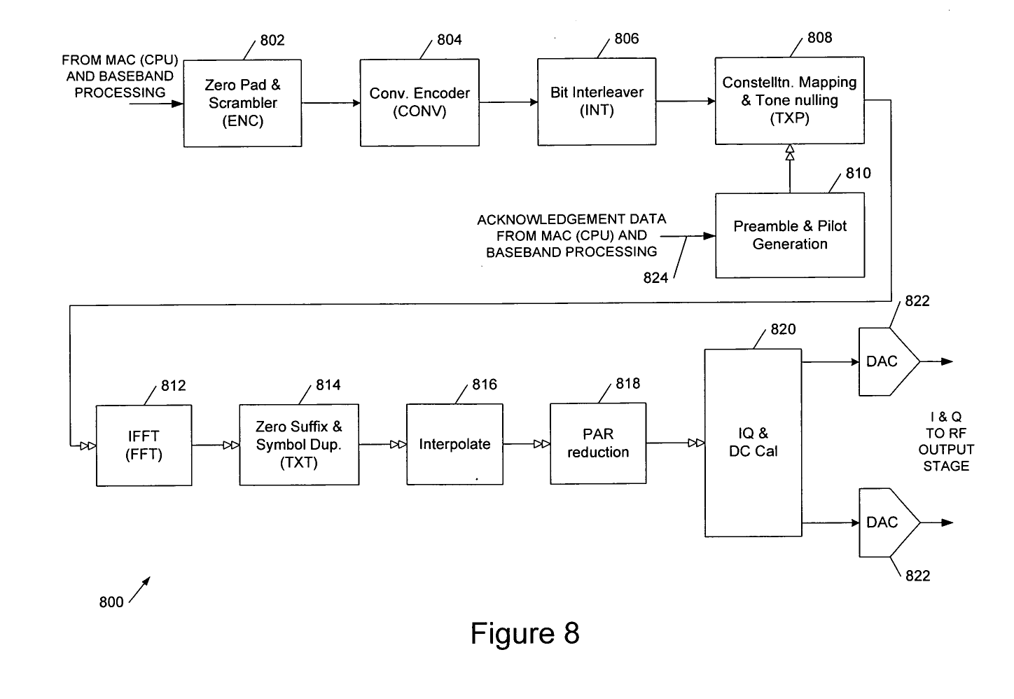

Referring now to FIG. 7, this shows details of the acknowledgment data 402. Thus, in embodiments, the time interval between two successive packets in a dense burst comprises 6 OFDM symbol intervals (if a period equal to that of the MIFS gap is employed). Allowing one symbol interval for the round trip between the transmitter and receiver (approximately 50 meters each way for a 300 nanosecond time interval), this provides 5 OFDM symbols which may be employed to encode the acknowledgement. As mentioned in the summary of the invention, the acknowledgement is sent using synchronisation symbols, modulated with a cover sequence, and since the absolute sign of a symbol (normal or inverted) is not known a differential code is used. Thus in embodiments an acknowledgement is sent using a minimum of two synchronisation symbols, but preferably more symbols, for example 5 symbols are employed for greater certainty. Typically the acknowledgement data encodes a “yes” or “no” in relation to successful reception of a prior packet. More particularly the acknowledgement refers to the packet before the last, not the most immediate pack, in order to facilitate operation of the receive and transmit pipelines.

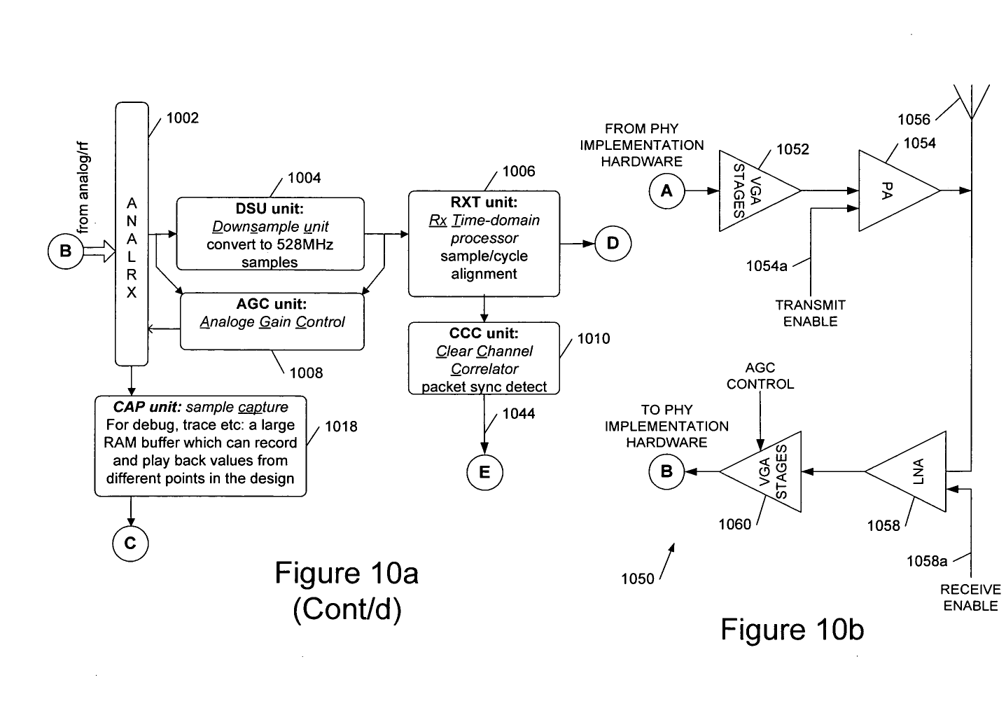

Such a technique enables a dense burst code to achieve a throughout of up to 426 Mpbs, that is 89% of the raw 480 Mbps payload rate, with buffering requirements approximately the same as a two-packet acknowledge using the WiMedia protocol of FIG. 3. Compared to the 331 Mbps rate achieved using the protocol of FIG. 3a, this represents a 28% increase in acknowledged throughput, and a similar improvement in overall air efficiency. Further there is negligible hardware cost, the technique is upwards compatible with conventional UWB transceivers (given the MAC capabilities these have for the protocol of FIG. 2 and FIGS. 3a and 3b). Further there is only a minor impact of the RF and MAC design. The RF circuitry should be able to switch between transmit and receive modes within well under an OFDM symbol period, but this is readily achievable, for example with the arrangement of FIG. 10b shown later. Preferably the MAC should be able to retransmit a not-acknowledged packet of a dense burst mode, but again this is straightforward to implement.

As previously mentioned, in some preferred implementations the transmit power of the acknowledge is reduced compared with that normally used for transmission of a synchronisation sequence and, for example, the transmit power may be determined using the receiver gain setting (a reciprocal gain concept) or by using the result of an error measurement such as an EVM (error vector magnitude) measurement. At the transmitter end (receiving the acknowledgment) the AGC need not then be used for the acknowledgement synchronisation symbols.

In some embodiments of the protocol the acknowledgement may employ a shortened version of the same correlation algorhythm as the packet synch sequence, preferably under a shortened cover sequence. However, one issue of potential concern is that if a force ACK is received then the entire dense burst mode burst block of packets may need to be disregarded causing re-transmission problems. Such a force ACK might arise, for example, from an adjacent overlapping network, particularly if just a few synch symbols are employed to encode the acknowledge data. A solution to this is to employ a sequence of synchronisation symbols for encoding the acknowledgement data which is not in any legal synchronisation sequence defined by the standard for synchronisation purposes. Thus, for example, where five OFDM symbols are employed the acknowledgment data may be encodes using a 4-byte sequence (5 symbols each with a plus one or minus one cover sequence). Some examples of sequence which may be employed are as follows:
1010—Not present in tf codes 1 to 4 or tf codes 8 to 10
1100—Not present in tf codes 5 to 7
(a tf code is a time-frequency code used for synchronisation)

Thus, in one embodiment, the five symbols which may be employed are either 1010 or 1100 followed by, say a 1 for ACK, and a 0 for NAK. In a variant, after the gap 36 between the first and second packets 400a, 400b the round trip time between the transmitter and receiver is known and this the timing of the acknowledgment data is also known very accurately (for example to of order nanoseconds) and thus this very precise timing offset can also be used to discriminate acknowledgement data from false acknowledgement data. In general, however, such a technique is not necessary if an illegal sync sequence is employed. In a further refinement the acknowledgement data may be sent at FFI (fixed frequency interleaving) strength and the acknowledgement data may stay in a single band, for example the lowest band available/permissible for use, and hopping can be disabled.

In another refinement, as previously noted although the timing offset between the transmitter and receiver is unpredictable, once this offset has been acquired timing synchronisation may be maintained to keep the transmitter and receiver in step. In this situation it becomes less important to use an illegal synchronisation sequence for the acknowledgment data and thus, for example, the acknowledgement data may include additional encoded data as well as the ACK/NAK. Further, the acknowledgement data need not then be restricted to synchronisation symbols, further enhancing the quantity of encoded data which may be carried on this “back channel”. However such a technique could make the acknowledgements bigger, which may be less preferable, and might also need to rely upon high quality/more frequent channel estimation. Potentially, however, considering a dense burst at 960 Mbps, 1800 user bits might be available for a group of six OFDM symbols so that, for example, 4095 user bytes might be encoded using 196-symbol blocks in the payload, that is 114 symbols.

Turning now to the final payload acknowledgement 404, although in the example protocol of FIG. 4 a SIFS interval 30 is shown prior to this acknowledgement, this SISF interval may be reduced or even removed entirely to provide a further improvement. Consider a case as shown in FIG. 4 where an acknowledgement is being sent in response to a dense burst. Since the MAC knows that it (in this particular embodiment) must provide an answer to the burst, we introduce a NAK packet so that the MAC always ahs a default packet to send. The then receiving PHY can perform an auto-turnaround and begin transmitting the preamble or synchronisation sequence of the acknowledgement 404 whilst the MAC is deciding whether to ACK or NAK this data. Optionally another separate header bit may be employed to select such an auto-acknowledgement mode; alternatively this could be mandatory for higher data rates. Such a technique may also be employed with a single data packet of the general type shown in FIG. 2, as well as with burst or dense burst mode packets. Around 10% further benefit is potentially available through this technique.

A still further option for reducing the SIFS interval 30 is to use a packet which has already been sent in the opposite direction (that is from the receiver to the transmitter) to send acknowledgement data. In general in an OFDM UWB transceiver network there will often be data travelling in both directions and, say, a dense burst mode set of packets sent in one direction may be followed by at least one packet sent in the opposite direction. If there are such packets up to 40% improvement at 408 Mbps, 60% improvement at 960 Mbps may be achieved by piggybacking the acknowledgement onto a packet travelling in the opposite direction anyway. An acknowledgement sent in this way, for example, may be included in a header of a packet travelling in the opposite direction, or in the payload or incorporated into the packet in some other way.

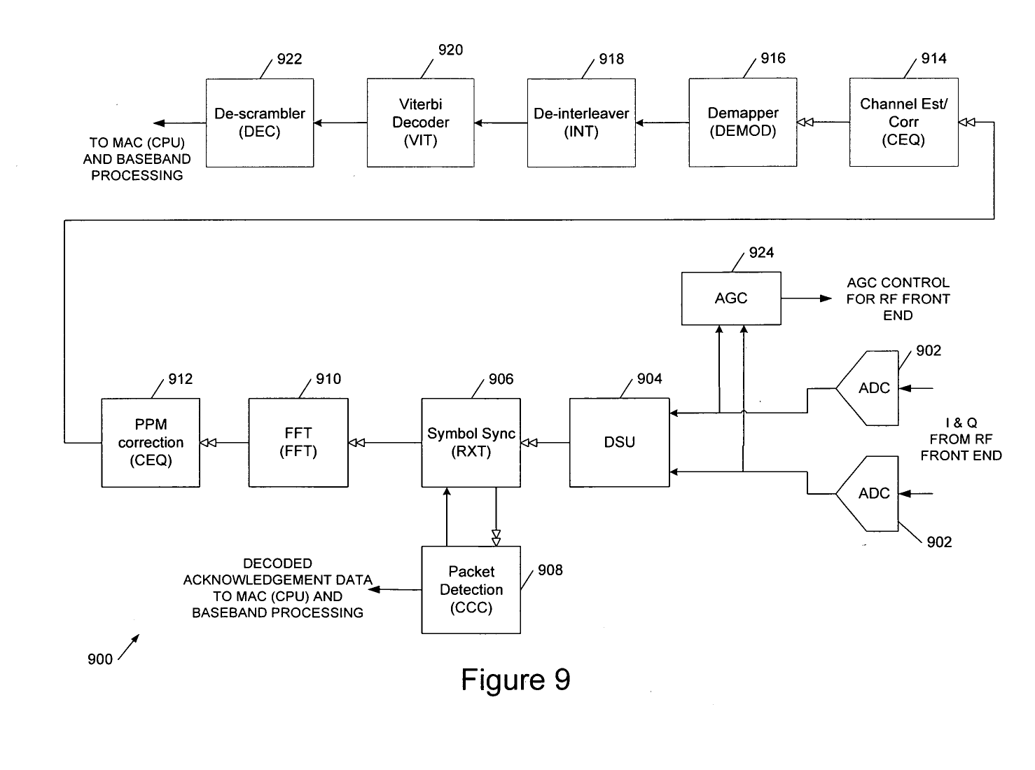

FIG. 8 shows a block diagram of a digital transmitter sub-system 800 of an OFDM UWB transceiver configured for receiving a dense burst mode set of packets from a transmitting UWB transceiver of a similar type. The sub-system in FIG. 8 shows functional elements; in practice hardware, in particular the (I) FFT may be shared between transmitting and receiving portions of a transceiver since the transceiver is not transmitting and receiving at the same time.

Referring to FIG. 8 data for transmission from the MAC CPU (central processing unit) is provided to a zero padding and scrambling module 802 followed by a convolution encoder 804 for forward error correction and bit interleaver 806 prior to constellation mapping and tone nulling 808. At this point pilot tones are also inserted and a synchronisation sequence is added by a preamble and pilot generation module 810. An IFFT 812 is then performed followed by zero suffix and symbol duplication 814, interpolation 816 and peak-to-average power ratio (PAR) reduction 818 (with the aim of minimising the transmit power spectral density whilst still providing a reliable link for the transfer of information). The digital output at this stage is then converted to I and Q samples at approximately 1 Gsps in a stage 820 which is also able to perform DC calibration, and then these I and Q samples are converted to the analogue domain by a pair of DACs 822 and passed to the RF output stage.

To implement a dense burst mode as described above the transmitter subsystem of the receiving transceiver is further configured to be able to send and acknowledge in a gap between received packets of a dense burst of packets, by encoding the acknowledgment data to be sent using synchronisation symbols. In the illustrated transmitter this is implemented by a link between the MAC which provides the acknowledgment data and the preamble and pilot generation module 810, which encodes the acknowledgement data by modulating synchronisation symbols with a cover sequence to define either an ACK or NAK signal for return to the burst mode packet transmitter. The RF front end of the transceiver is preferably switched between receive and transmit by the PHY rather than the MAC.

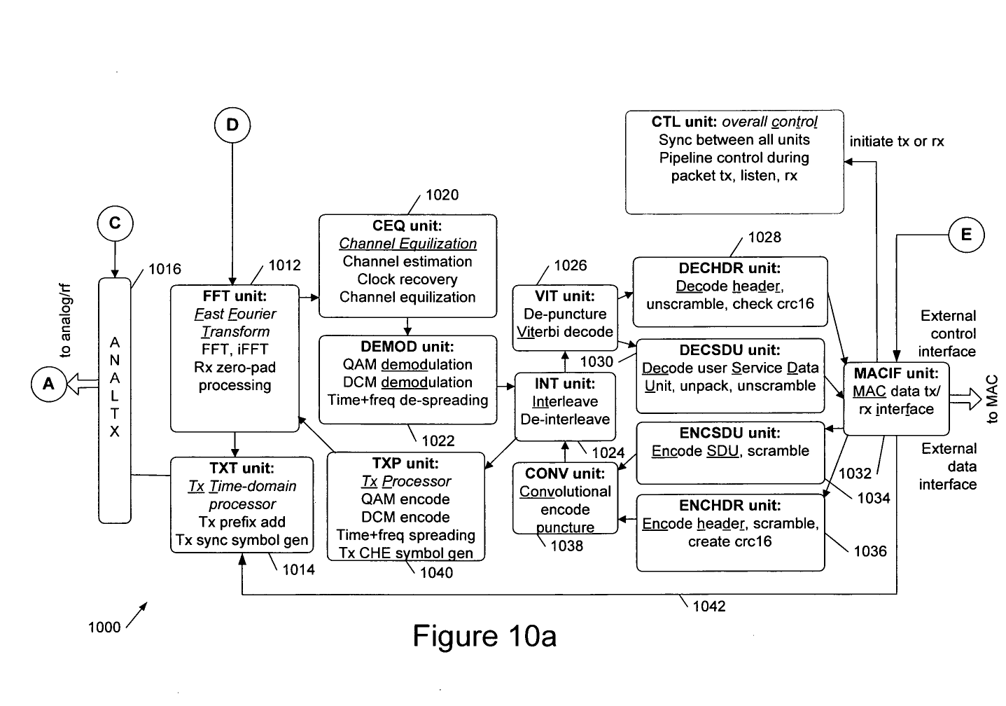

FIG. 9 shows a digital receiver sub-system 900 of a transceiver sending a dense burst of packets, in particular configured to receive and decode acknowledgement data transmitted from the receiver between packets of the dense burst.

Referring to FIG. 9, analogue I and Q signals from the RF front end are digitised by a pair of ADCs 902 and provided to a down sample unit (DSU) 904. Symbol synchronisation 906 is then performed in conjunction with packet detection/synchronisation 908 using the preamble synchronisation symbols. An FFT 910 then performs a conversion to the frequency domain and PPM (parts per million) clock correction 912 is performed followed by channel estimation and correlation 914. After this the received data is demodulated 916, de-interleaved 918, Viterbi decoded 920, de-scrambled 922 and the recovered data output to the MAC. An AGC (automatic gain control) unit is coupled to the outputs of a ADCs 902 and feeds back to the RF front end for AGC control, also on the control of the MAC.

The digital receiver sub-system of the burst mode packets sending transceiver is configured to decode the acknowledgement data sent by the receiver encoded by modulating a series of synchronisation symbols with a cover sequence, and this acknowledgement data can straightforwardly be extracted from the packet detection module 908 and provided to the MAC. The MAC is configured to re-transmit not-acknowledged packets of a dense burst, preferably as part of the same packet burst, for example in the first available packet slot, in order to reduce buffering requirements. However there are many ways for the MAC to retransmit one or more not-acknowledged packets. Re-transmission of a packet may be indicated in one or more header bits. (The start of a dense burst-itself is preferably indicated in the header of the first packet of the burst.

FIG. 10a shows a block diagram of physical hardware modules of a UWB OFDM transceiver 1000 which implements the transmitter and receiver functions depicted in FIGS. 8 and 9. The labels in brackets in the blocks of FIGS. 8 and 9 correspond with those of FIG. 10a, illustrating how the functional units are mapped to physical hardware.

Referring to FIG. 10a an analogue input 1002 provides a digital output to a DSU (down sample unit) 1004 which converts the incoming data at approximately 1 Gsps to 528 Mz samples, and provides an output to an RXT unit (receive time-domain processor) 1006 which performs sample/cycle alignment. An AGC unit 1008 is coupled around the DSU 1004 and to the analogue input 1002. The RXT unit provides an output to a CCC (clear channel correlator) unit 1010 which detects packet synchronisation; RXT unit 1006 also provides an output to an FFT unit 1012 which performs an FFT (when receiving) and IFFT (when transmitting) as well as receiver 0-padding processing. The FFT unit 1012 has an output to a TXT (transmit time-domain processor) unit 1014 which performs prefix addition and synchronisation symbol generation and provides an output to an analogue transmit interface 1016 which provides an analogue output to subsequent RF stages. A CAP (sample capture) unit 1018 is coupled to both the analogue receive interface 1002 and the analogue transmit interface 1016 to facilitate debugging, tracing and the like. Broadly speaking this comprises a large RAM (random access memory) buffer which can record and playback data captured from different points in the design.

The FFT unit 1012 provides an output to a CEQ (channel equalisation unit) 1020 which performs channel estimation, clock recovery, and channel equalisation and provides an output to a DEMOD unit 1022 which performs QAM demodulation, DCM (dual carrier modulation) demodulation, and time and frequency de-spreading, providing an output to an INT (interleave/de-interleave) unit 1024. The INT unit 1024 provides an output to a VIT (Viterbi decode) unit 1026 which also performs de-puncturing of the code, this providing outputs to a header decode (DECHDR) unit 1028 which also unscrambles the received data and performs a CRC 16 check, and to a decode user service data unit (DECSDU) unit 1030, which unpacks and unscrambles the received data. Both DECHDR unit 1028 and DECSDU unit 1030 provide output to a MAC interface (MACIF) unit 1032 which provides a transmit and receive data and control interface for the MAC.

In the transmit path the MACIF unit 1032 provides outputs to an ENCSDU unit 1034 which performs service data unit encoding and scrambling, and to an ENCHDR unit 1036 which performs header encoding and scrambling and also creates CRC 16 data. Both ENCSDU unit 1034 and ENCHDR unit 1036 provide output to a convolutional encode (CONV) unit 1038 which also performs puncturing of the encoded data, and this provides an output to the interleave (INT) unit 1024. The INT unit 1024 then provides an output to a transmit processor (TXP) unit 1040 which, in embodiments, performs QAM and DCM encoding, time-frequency spreading, and transmit channel estimation (CHE) symbol generation, providing an output to (I)FFT unit 1012, which in turn provides an output to TXT unit 1014 as previously described.

To enable the acknowledgement data to be encoded using synchronisation symbols the MACIF unit 1032 has an output 1042 to the TXT unit 1014. The decoded acknowledgement data may be extracted from the CCC unit 1010, which in embodiments has an output 1044 to the MACIF unit 1032. In embodiments the MACIF unit coordinates transmission and reception of the acknowledgement data included between data packets in dense burst mode packet transmission.

Referring now to FIG. 10b, this shows, schematically, RF input and output stages 1050 for the transceiver of FIG. 10a. The RF output stages comprise VGA stages 1052 followed by a power amplifier 1054 coupled to antenna 1056. The RF input stages comprise a low noise amplifier 1058, coupled to antenna 1056 and providing an output to further multiple VGA stages 1060 which provide an output to the analogue receive input 1002 of FIG. 10a. The power amplifier 1054 has a transmit enable control 1054a and the LNA 1058 has a receive enable control 1058a; these are controlled to switch rapidly between transmit and receive modes.

Broadly speaking embodiments of the techniques we describe provide a number of benefits including more efficient use of air time, higher acknowledged data throughput, and reduced buffering requirements in embedded, more particularly single-chip systems.

No doubt many other effective alternatives will occur to the skilled person. It will be understood that the invention is not limited to the described embodiments and encompasses modifications apparent to those skilled in the art lying within the spirit and scope of the claims appended hereto.

What is claimed is:

1. A method of sending a burst of data packets from a first OFDM transceiver to a second OFDM transceiver, said transceivers having a set of OFDM synchronisation symbols for synchronising communications between the transceivers, the method comprising:
(a) sending said data packets from said first to said second transceiver, and
(b) between sending at least some of said data packets of said burst receiving acknowledgement data from said second transceiver at said first transceiver; and
(c) wherein said acknowledgement data is encoded using said OFDM synchronisation symbols.

2. A method as claimed in claim 1 wherein said acknowledgement data is encoded by modulating a sequence of said synchronisation symbols with a cover sequence.

3. A method as claimed in claim 2 wherein said modulating uses a differential code comprising inverted and non-inverted versions of said synchronisation symbols.

4. A method as claimed in claim 2 wherein one or more sequences of said synchronisation symbols are legal for use in said synchronising of communications, and wherein said sequence of synchronisation symbols modulated by said cover sequence comprises sequence not used for said synchronising of communications between the transceivers.

5. A method as claimed in claim 4 wherein none of said legal synchronisation symbol sequences is transmitted by said first transceiver between said data packets of said burst.

6. A method as claimed in claim 5 wherein said second transceiver performs tracking of a transmit clock of said first transceiver over substantially all of a duration of said burst.

7. A method as claimed in claim 1 wherein said acknowledgement data is encoded using 12 or less of said synchronisation symbols.

8. A method as claimed in claim 1 wherein said acknowledgement data consists of a single bit of data encoded using at least two of said synchronisation symbols.

9. A method as claimed in claim 1 wherein said acknowledgement data comprises data defining packet reception acknowledged and not acknowledged encoded using at least three of said synchronisation symbols.

10. A method as claimed in claim 1 wherein said acknowledgement data is encoded using at least five of said synchronisation symbols.

11. A method as claimed in claim 1 wherein an interval between said first transceiver completing sending a said data packet of said burst and receiving a first symbol of said acknowledgement data is less than an OFDM symbol duration.

12. A method as claimed in claim 11 wherein an interval between said first transceiver receiving a last symbol of said acknowledgement data and starting sending a next data packet of said burst is less than an OFDM symbol duration.

13. A method as claimed in claim 1 wherein said acknowledgement data relates to a data packet before a most recently sent data packet of said burst.

14. A method as claimed in claim 1 wherein only an initial data packet of said burst includes more of said synchronisation symbols than used to encode said acknowledgement data.

15. A method as claimed in claim 1 wherein an acknowledgement of a plurality of said packets of said burst is sent by said second transceiver after reception of said final packet.

16. A method as claimed in claim 1 wherein said burst has a maximum throughput data transmission rate of at least 400 Mbps.

17. A method as claimed in claim 1 wherein said first and second transceivers comprise UWB transceivers.

18. A method as claimed in claim 1 wherein said first and second transceivers are backwards compatible with WiMedia standard 1.1 or 1.2 physical layer interface.

19. A method as claimed in claim 1 wherein said first and second transceivers comprise transceivers of a wireless local or personal area network.

20. A UWB transceiver burst mode packet data communications protocol for operation at a raw data rate of at least 400 Mbps, in said burst mode a burst of data packets being transmitted, the protocol comprising sending an initial data packet with a synchronisation sequence then sending a succession of subsequent data packets of said burst, and wherein acknowledgement data for a packet is received between transmissions of said subsequent data packets.

21. A protocol as claimed in claim 20 wherein said acknowledgement data for a packet comprises acknowledgement data for a previous but one transmitted packet.

22. A protocol as claimed in claim 20 wherein said burst mode communications is halted if said acknowledgement data cannot be decoded by a said UWB transceiver.

23. A protocol as claimed in claim 20 wherein said acknowledgement data is encoded using synchronisation symbols of said protocol.

24. A protocol as claimed in claim 23 wherein said acknowledgement data is encoded by modulating said synchronisation symbols with a cover sequence which is not a valid synchronisation sequence.

25. A protocol as claimed in claim 20 wherein said acknowledgement data comprises a single data bit encoded using a plurality of symbols of said communications protocol.

26. A protocol as claimed in claim 20 lacking a synchronisation sequence between ones of said subsequent data packets.

27. A protocol as claimed in claim 20 wherein said protocol is for MultiBand OFDM (MBOFDM) UWB communications.

28. A protocol as claimed in claim 27 wherein said MBOFDM communication employs frequency hopping between said bands, and wherein communication of said acknowledgement data does not use said frequency hopping.

29. An OFDM UWB transceiver having a burst mode for packet data communications in which a burst of data packets is transmitted, the transceiver including synchronisation circuitry to synchronise received OFDM packets for demodulation, and wherein said transceiver is configured to use said synchronisation circuitry during intervals between transmission of data packets of a said burst to receive acknowledgement data for said data packets of said burst.

30. An OFDM UWB transceiver as claimed in claim 29 wherein said transceiver is configured to use said synchronisation circuitry to decode said acknowledgement data from a sequence of synchronisation symbols.

31. An OFDM UWB transceiver having a burst mode for packet data communications in which a burst of data packets is received, wherein said transceiver is configured to send acknowledgement data for said data packets of said burst encoded using synchronisation symbols.

32. An OFDM UWB transceiver as claimed in claim 31 wherein said transceiver is configured to send said acknowledgement data between reception of said data packets of said burst.

33. An OFDM UWB signal comprising a burst of data packets preceded by a synchronisation sequence including synchronisation symbols, in which acknowledgement data is included between said data packets, said acknowledgement data being encoded using said synchronisation symbols.

34. A method of acknowledging a data packet in an OFDM UWB packet data communications system, the method comprising transmitting at least one data packet from a first transceiver to a second transceiver and acknowledging reception of said at least one data packet by sending an acknowledgement packet from said second to said first transceiver, said acknowledgement packet including a synchronisation sequence followed by an acknowledgement payload defining whether reception of said at least one data packet is acknowledged, and wherein said sending of said synchronisation sequence of said acknowledgement packet commences before said second transceiver has determined whether said reception of said at least one data packet is to be acknowledged.

35. A method as claimed in claim 35 wherein said sending of said synchronisation sequence of said acknowledgement packet commences substantially immediately after said reception of said at least one data packet.

36. A data carrier carrying processor control code to implement the method of claim 34.

37. An OFDM UWB data communications device, said data communications device comprising a transceiver to receive at least one data packet from another transceiver and to acknowledge reception of said at least one data packet by sending an acknowledgement packet to said other transceiver, said acknowledgement packet including a synchronisation sequence followed by an acknowledgement payload defining whether reception of said at least one data packet is acknowledged; and wherein said transceiver is configured to commence sending of said synchronisation sequence of said acknowledgement packet before said transceiver has determined whether said reception of said at least one data packet is to be acknowledged.

38. A data carrier carrying processor control code to implement the method of claim 1.

39. An OFDM transceiver having a burst mode for sending a burst of data packets to a second OFDM transceiver, said transceiver having a set of OFDM synchronisation symbols for synchronising communications between the transceivers, the OFDM transceiver comprising:
(a) an OGFDM transmitter to send said data packets of said burst to said second OFDM transceiver; and
(b) an OFDM receiver to receive acknowledgement data between sending at least some of said data packets of said burst, wherein said acknowledgement data is encoded using said OFDM synchronisation symbols.

40. A UWB communications system having a burst mode packet data communications protocol for operation at a raw data rate of at least 400 Mbps, in said burst mode a burst of data packets being transmitted, the protocol comprising sending an initial data packet with a synchronisation sequence then sending a succession of subsequent data packets of said burst, and wherein acknowledgement data for a packet is received between transmissions of said subsequent data packets.

41. An OFDM UWB receiver for an OFDM UWB packet data communications system, the receiver comprising a system for acknowledging reception of a data packet by sending an acknowledgement packet said acknowledgement packet including a synchronisation sequence followed by an acknowledgement payload defining whether reception of said at least one data packet is acknowledged, and wherein said receiver is configured to commence said sending of said synchronisation sequence of said acknowledgement packet before the receiver has determined whether said reception of said at least one data packet is to be acknowledged.
